(19) United States
(12) Patent Application Publication
(10) Pub. No.: US 2026/0162125 A1
(43) Pub. Date: Jun. 11, 2026

(54) ECOCOM ENGINE(S) FOR ANALYZING AND SUPPORTING ECO-CONSCIOUS DIGITAL COMMUNICATIONS

(71) Applicant: Oracle International Corporation, Redwood City, CA (US)

(72) Inventors: Adya Kiran, Udupi (IN); Twinkle Arora, Hyderabad (IN); Manish Kumar, Hyderabad (IN); Venugopal Machiraju, Hyderabad (IN); Javed Akhtar, Hyderabad (IN)

(21) Appl. No.: 18/975,218

(22) Filed: Dec. 10, 2024

(51) Int. Cl. G06Q 30/018

(52) U.S. Cl. CPC G06Q 30/018

(57) ABSTRACT

Various embodiments of the present technology generally relate to systems and methods for providing an Eco-Conscious Communication (EcoCom) engine for analyzing and supporting eco-conscious digital communications. In an example, the EcoCom engine detects a digital communication prepared by a client device via a communications application. Upon detection, the EcoCom engine parses the digital communication to determine one or more features of the digital communication. Based on the one or more features, the EcoCom engine computes a carbon footprint estimate for the digital communication and generates a visual indication of the carbon footprint estimate. The visual indication of the carbon footprint estimate is displayed as associated with the digital communication via the client device, such as in visual proximity to the digital communication to communicate the environmental impact of the digital communication.

### TECHNICAL FIELD

Various embodiments of the present technology generally relate to digital communications and services. More specifically, embodiments of the present technology relate to systems and methods for providing an Eco-Conscious Communication (“EcoCom”) engine for analyzing and supporting eco-conscious digital communications.

### BACKGROUND

Digital communication, particularly email, has firmly established itself as a cornerstone of modern life, permeating both professional and personal realms. In the business world, email functions as a vital communication tool, enabling seamless collaboration, efficient information exchange, and productivity across teams and locations. Simultaneously, in personal contexts, it serves as a bridge for maintaining relationships across distances, allowing individuals to stay connected regardless of geographical boundaries. With its widespread adoption and integration into daily routines, digital communication has evolved from a mere convenience to an essential component of contemporary life.

While digital communication has become indispensable, its environmental impact is often overlooked. Each digital communication sent or received contributes to carbon emissions, primarily due to the energy required for data storage and transmission. Research from the Carbon Trust indicates that a single email generates approximately 0.02 grams of CO₂ [1]. Though this may appear minimal, the cumulative effect is significant when considering the billions of emails sent each day worldwide. An average office worker, for instance, sends and receives around 121 emails daily [2], contributing to roughly 3,120 kilograms of CO₂ emissions per year. Additionally, digital communications containing attachments or heavy graphics produce even higher emissions—potentially up to 50 grams of CO₂ per communication [3]. Given the vast scale of digital communication globally, the carbon footprint associated with digital communication usage has become a pressing environmental concern.

Accordingly, there exists a need for improved systems and techniques to monitor and supervise the environmental impact of digital communication. Specifically, there exists a need for EcoCom engine(s) as provided herein to provide real-time feedback on the environment impact of a respective digital communication and provide options for reducing the environmental impact of exchanged digital communications.

The information provided in this section is presented as background information and serves only to assist in any understanding of the present disclosure. No determination has been made and no assertion is made as to whether any of the above might be applicable as prior art with regard to the present disclosure.

### REFERENCES

[1] Carbon Trust. (2010). Carbon impacts of ICT: Insights from the Carbon Trust footprinting study. Retrieved from https://www.carbontrust.com/;
[2] Radicati Group. (2019). Email statistics report, 2019-2023. Retrieved from https://www.radicati.com/;
[3] Lancaster University. (2019). Carbon footprint of spam emails. Retrieved from https://www.lancaster.ac.uk/news/articles/2019/carbon-footprint-of-spam-emails;
[4] Carbon Literacy Project. (n.d.). Email Footprint; and
[5] McAfee, A. (2010). The carbon footprint of email spam reports. ICF International. Retrieved from [McAfee Spam Carbon Footprint Report].

### OVERVIEW

Technology is disclosed herein for systems and techniques for providing an EcoCom engine to provide real-time feedback on the environment impact of a respective digital communication and provide options for reducing the environmental impact of exchanged digital communications. In an example, the EcoCom engine detects a digital communication during drafting by a client device. The EcoCom engine may be a plug-in within a communications application such that when the client device prepares a digital communication within the communications application, the EcoCom engine readily detects it. Once detected, the EcoCom engine parses the digital communication to determine the features of the digital communication. Features include attachments, a number of indicated recipients, and whether or not the digital communication is a chain communication.

Based on the features, the EcoCom engine generates a carbon footprint estimate for the digital communication. The carbon footprint estimate may be computed during the drafting of the digital communication or after the digital communication is sent. The EcoCom engine generates and provides visual indications of the environmental impacts of the features of the digital communications as well as the carbon footprint estimate to the client device. The visual indications may be displayed within visual proximity to the digital communication such to inform a user of the client device of the environmental impact of the respective communication. As will be expanded on in greater detail below, the EcoCom engine may also generate a summary of the environmental impact of digital communications exchanged over a predefined period of time to provide a snapshot of how eco-friendly the digital communications are for a respective client device.

This overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment in which an EcoCom engine is implemented to monitor and supervise the environmental impact of digital communications, according to an embodiment herein;

FIG. 2 illustrates an example operational environment in which an EcoCom engine is implemented to monitor and analyze a digital communication prepared by a client device, according to an embodiment herein;

FIG. 3 provides an example EcoCom engine process, according to an embodiment herein;

FIG. 4 illustrates an example digital communication, according to an embodiment herein;

FIG. 5 illustrates an example inbox containing multiple digital communications including respective visual indications, according to an embodiment herein;

FIG. 6 illustrates an example summary, according to an embodiment herein; and

FIG. 7 shows an example computing device suitable for providing an EcoCom engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Environmental concerns are gaining prominence as awareness grows about the urgent need to reduce carbon emissions across all aspects of modern life. While industries like manufacturing and transportation are often the focus of sustainability efforts, digital communication remains an overlooked contributor to the carbon footprint. Activities such as sending emails, storing data, and managing large digital networks require substantial energy, most of which comes from data centers powered by fossil fuels. Each interaction, though small on its own, contributes to a larger cumulative impact as the volume of digital communication continues to rise globally.

Despite the carbon footprint associated with digital communications, many users remain unaware of its environmental impact, often assuming that online interactions are “clean” or energy-neutral. However, multiple features of a respective digital communication contribute to its carbon emissions. Data storage in vast server farms, the energy-intensive transmission of data through network infrastructure, and the processing power required for devices to send, receive, and store messages all play a role. Features like attachments, high-resolution images, and embedded videos increase the data load, requiring more energy and, thus, generating a higher carbon footprint per communication. Additionally, chain communications which archive large volumes of emails and messages over time compound the environment impact of a digital communication, as data centers must maintain and power extensive storage systems indefinitely. These factors collectively make digital communication a significant, yet often overlooked, source of carbon emissions.

While conventional approaches to sustainable digital communication, such as ProtonMail, Fastmail, and GreenGeeks, contribute valuable eco-friendly practices-like renewable energy usage for servers and green hosting solutions—these systems lack a direct focus on engaging users in active sustainability efforts. For example, some of these conventional systems leverage renewable energy for their servers or offset hosting energy consumption with wind power credits, others assist users in minimizing unnecessary email traffic, such as by unsubscribing from unwanted newsletters, thereby reducing server load. These conventional services, however, fall short in providing users with actionable insights into their own environmental impact and recommendations as to how to reduce their carbon footprint associated with a respective digital communication.

To address the shortcomings of conventional sustainable digital communication tools, an example EcoCom engine for monitoring and managing the environmental impact of digital communications is provided herein. As will be described in greater detail below, in an example the EcoCom engine detects a digital communication, such as during drafting by a client device, within a communications application. As the digital communication is drafted, the EcoCom may determine one or more features of the digital communication, such as whether it includes an attachment, whether the digital communication is part of a chain communication, and/or a number of recipients indicated to receive the digital communication. As used herein, a chain communication refers to a digital communication, such as an email or electronic message, that is circulated repeatedly by recipients forwarding or replying to the digital communication to others or amongst themselves.

Responsive to detecting the digital communication prior to its transmission, the EcoCom engine computes a carbon footprint estimate for the digital communication. For example, the EcoCom engine determines a server energy consumption based on the communications application associated with the digital communication and determines an energy source emissions factor based on the digital communication. Then, using the server energy consumption, the energy source emissions factor, and the features of the digital communication, the EcoCom engine generates a carbon footprint estimate for the digital communication. The EcoCom engine may be a plug-in that analyzes each digital communication as it is prepared within the communications application such to compute a carbon footprint estimate for a respective digital communication prior to or upon transmission.

Once a carbon footprint estimate is generated for a respective digital communication, the EcoCom engine provides the carbon footprint estimate to the client device. For example, the EcoCom engine generates a visual representation of the carbon footprint estimate and displays the visual representation within visual proximity of the digital communication. By providing the carbon footprint estimate to the client device, such as by displaying it as associated with the digital communication, a user of the client device can be notified of the environmental impact of the respective communication. In some embodiments, the EcoCom engine may generate an eco-score indicating the environmental impact of the digital communication. For example, based on the carbon footprint estimate, the EcoCom engine generates an eco-score of low impact, medium impact, or high impact. In addition to indicating a carbon footprint estimate for a digital communication, the EcoCom engine may generate a recommendation on how the user can reduce the overall environmental impact of the digital communication, such as compressing an attachment, starting a new email instead of forwarding or replying on a chain communication, or reducing the number of intended recipients.

By providing real-time feedback on the energy consumption and emissions related to emails, messages, and file sharing, the EcoCom engine empowers users to make informed decisions and adopt more sustainable practices, such as optimizing file sizes, reducing email attachments, or prioritizing lower-impact communication channels. This transparency not only raises awareness about individual environmental impact but also promotes a culture of digital responsibility within organizations, encouraging more sustainable IT and communication practices. Additionally, the EcoCom engine may contribute to corporate sustainability goals by enabling tracking and reduction of emissions from digital infrastructure, helping organizations meet environmental targets and fostering a greener digital ecosystem.

Moreover, the EcoCom engine provides substantial benefits in terms of energy savings, bandwidth optimization, and reduction in server traffic, thereby positively impacting the digital infrastructure that supports digital communications. By promoting environmentally friendly and efficient practices-such as minimizing email attachments, compressing files, or selecting lower-energy communication options—the EcoCom engine reduces the data volume that servers need to process, store, and transmit. This, in turn, lowers the energy consumption of data centers, mitigates network congestion, and enhances infrastructure performance, particularly during peak times. These efficiencies not only extend the lifespan of server hardware, reducing the frequency of costly upgrades and electronic waste, but also contribute to a smaller overall carbon footprint for digital communication networks, aligning with broader sustainability goals while lowering operational costs for providers.

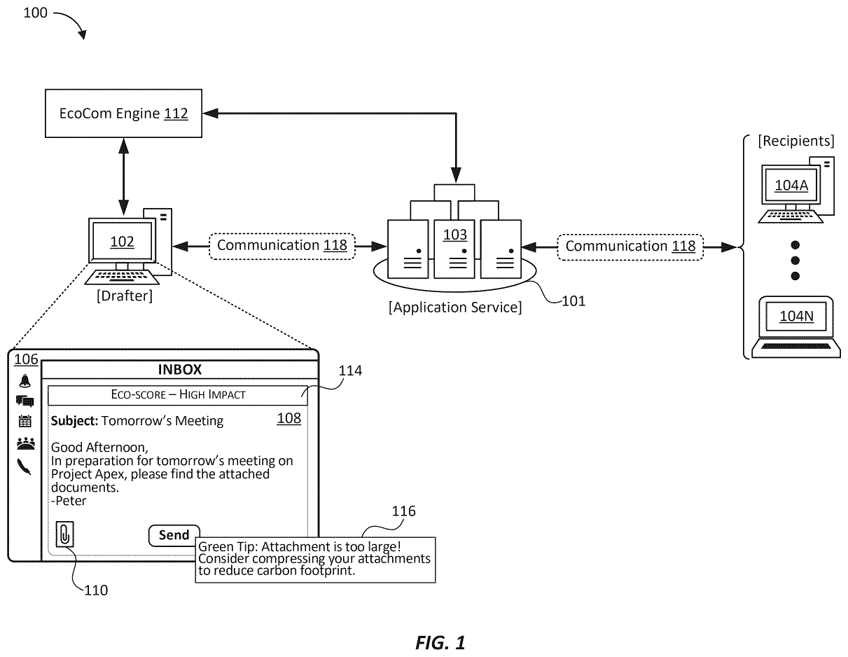

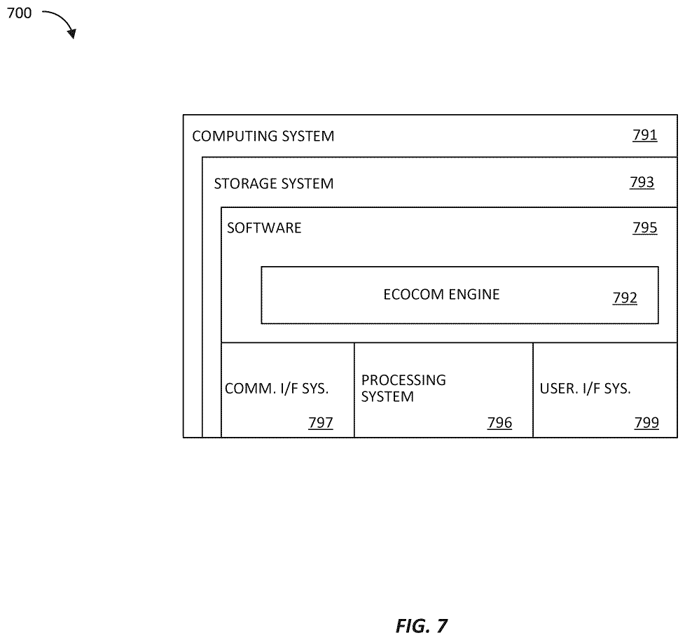

Turning now to the Figures, FIG. 1 illustrates an example operational environment 100 in which an EcoCom engine 112 may be implemented to monitor and supervise the environmental impact of digital communications, according to an embodiment herein. As illustrated, the operational environment 100 includes an application service 101 which delivers services to client devices 102 and client devices 104A-N. It should be appreciated that any number of client devices 102 and 104A-N may interact with the application service 101, a limited number is illustrated for ease of explanation. Examples of the client device 102 may include personal computers, tablet computers, mobile phones, gaming consoles, wearable devices, Internet of Things (IoT) devices, and any other suitable devices, of which computing apparatus 791 in FIG. 7 is also broadly representative.

As shown, the application service 101 provides one or more functions or features to the client device 102 and client devices 104A-N. Broadly speaking, the application service 101 provides software application services to end points, such as the client devices 102 and 104A-N, examples of which include digital communication software, such as a communications application, for facilitating seamless digital interactions between users (e.g., emails, messaging, posts, blogs). The client device 102 may load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

To interact with the application service 101, the client device 102 may communicate with the application service 101 via one or more internets and intranets, the Internet, wired and wireless networks, local area networks (LANs), wide area networks (WANs), or any other type of network or combination thereof. In the illustrated example, the application service 101 operates in a cloud-based environment. As such, the application service 101 employs one or more server computers 103 co-located with respect to each other or distributed across one or more data centers to deliver its functionalities and services. Example servers include web servers, application servers, virtual or physical servers, or any combination or variation thereof, of which computing apparatus 791 in FIG. 7 is broadly representative.

As shown, the client device 102, which represents a drafter in the illustrated example, leverages the communications application provided by the application service 101 to draft a digital communication 108 and transmit the digital communication 108, via communication pathway 118, to one or more recipients 104A-N. It should be appreciated that while the digital communication 108 described herein is an email, other forms of digital communication are contemplated herein. Examples of digital communications 108 includes email exchange, instant messaging, text messaging, social media messaging, message posts, blog posts, and the like.

As described above, the digital communication 108 has an environmental impact that is often overlooked or not fully appreciated by users. For example, to exchange the digital communication 108 with its indicated recipients (e.g., client devices 104A-N), the server computers 103, which host the application service 101 providing the communications application, continuously draw power to ensure that messages are sent, received, and retained for future access. That is, the exchange process for digital communications requires energy for both data transmission and long-term storage, contributing to greenhouse gas emissions.

Moreover, the features of a specific digital communication 108 also contribute to the carbon footprint of the digital communication 108. For example, as the number of recipients (e.g., client devices 104A-N) increases, the energy required for data transfer and storage across multiple servers computers 103 also increases. Similarly, the size of any attachments, such as an attachment 110, included in the digital communication 108 also impacts the carbon footprint of the communication. Larger files demand more bandwidth to transmit and more storage space on the server computers 103, thus increasing energy use and emissions. Yet another feature of the digital communication 108 that influences the environmental impact is whether the communication is a chain communication, such as a long email thread. Each time a chain communication is forwarded or replied to, a new instance of the digital communication 108 is created, requiring additional transmission and storage across the server computers 103. As the chain communication grows in content and/or recipients (e.g., client devices 104A-N), the cumulative energy demands increase, leading to a multiplied effect on the carbon footprint.

To aid users, such as the drafter associated with the client device 102, in monitoring and managing their environmental impact resulting from digital communications, the EcoCom engine 112 is leveraged, as described herein. As illustrated, the application service 101 may include an integration with the EcoCom engine 112 to monitor digital communications 108 generated by the client device 102, compute a carbon footprint estimate for a respective digital communication 108, and provide analysis of the environmental impact of the digital communication 108. In this manner, the EcoCom engine 112 empowers users to appreciate the environmental impact of their communication exchanges and take steps to reduce their overall carbon footprint.

In some embodiments, the EcoCom engine 112 is a plug-in of the communications application leveraged by the client device 102 to draft and send digital communications 108. As a plug-in, the EcoCom engine 112 seamlessly integrates with the communication application's existing infrastructure to enhance the communications application by adding specialized functionalities without requiring significant modifications to the application's core design. This embedded approach allows users to access and leverage the functionalities of the EcoCom engine 112 directly within the communication interface, providing a streamlined experience that feels native to the application.

In some cases, as a plug-in the EcoCom engine 112 may be executed locally on the client device 102. In other embodiments, the EcoCom engine 112 may be executed remotely by the application service 101 or a third party, while in still other embodiments, one or more functions of the EcoCom engine 112, as described herein, may be installed and executed locally on the client device 102, while the remaining functions are integrated and executed remotely via the application service 101 or a third party.

As noted above, once integrated into the communications application, the EcoCom engine 112 provides various functions and tools for analyzing and supporting eco-conscious digital communications. As illustrated, as the drafter, via the client device 102, drafts the digital communication 108, the EcoCom engine 112 detects the draft digital communication. As used herein, a draft digital communication is a digital communication that is being prepared for transmission to one or more recipients (e.g., client devices 104A-N), but has not yet been sent. Responsive to detecting the digital communication 108, the EcoCom engine 112 analyzes the features of the digital communication 108. For example, the EcoCom engine 112 parses the metadata associated with the digital communication 108 or header information, such as subject line or recipient fields to determine whether the digital communication 108 is a chain communication, whether the digital communication 108 includes the attachment 110, or a number of recipients indicated to receive the digital communication 108.

Based on the features detected by the EcoCom engine 112, the EcoCom engine 112 generates a carbon footprint estimate for the digital communication 108. As will be described in greater detail below, the EcoCom engine 112 computes the carbon footprint estimate based on a variety of factors including the features, along with the server energy consumption associated with the application service 101 and/or the energy source emissions factor associated with the application service 101 and the intended recipients. Once the carbon footprint estimate is generated by the EcoCom engine 112, the EcoCom engine 112 may generate an eco-score 114 indicating the environmental impact of the digital communication 108. Additionally, the EcoCom engine 112 may generate a recommendation 116 for how the drafter can reduce the environment impact or carbon footprint of the digital communication 108. One or both of the eco-score 114 and the recommendation 116 can be displayed via a user interface 106 on the client device 102 to the draft. As such, the drafter can review the environmental impact analysis provided by the EcoCom engine 112 may make modifications as required, thereby reducing the carbon footprint of the digital communication 108.

By transforming abstract concerns about sustainability into actionable insights, the EcoCom engine 112 informs users of their environmental impact, which is a vital step in reducing their carbon footprint. When individuals understand how daily choices-such as including larger attachments or forwarding/replying to a chain communication-affect the planet, they can make conscious, informed decisions that align with reducing their carbon output. The initial awareness provided by the EcoCom engine 112 empowers users to identify specific areas for improvement, set realistic goals, and track their progress, making sustainable habits easier to adopt and maintain. Knowledge, therefore, becomes the catalyst for meaningful, lasting change toward a greener lifestyle.

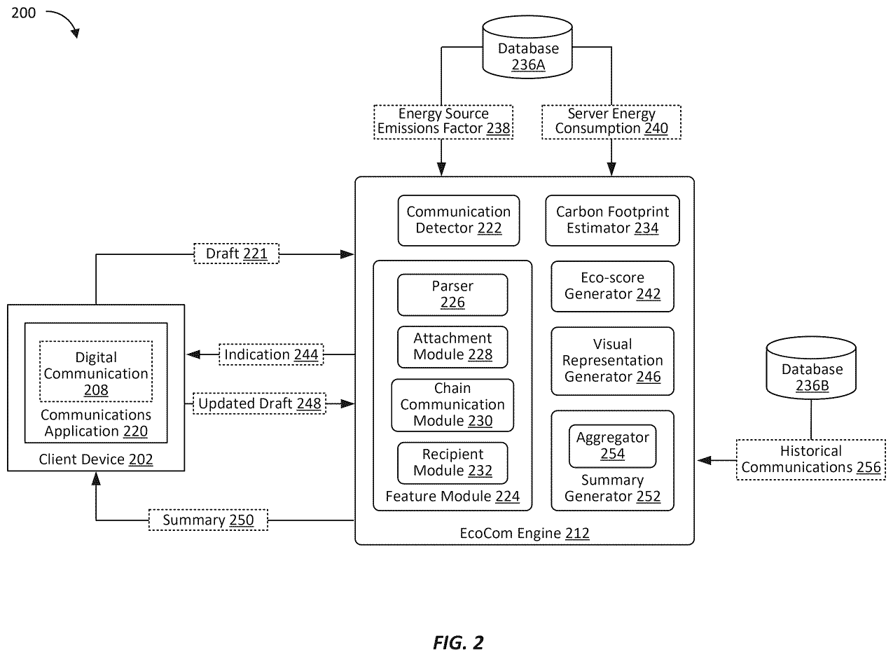

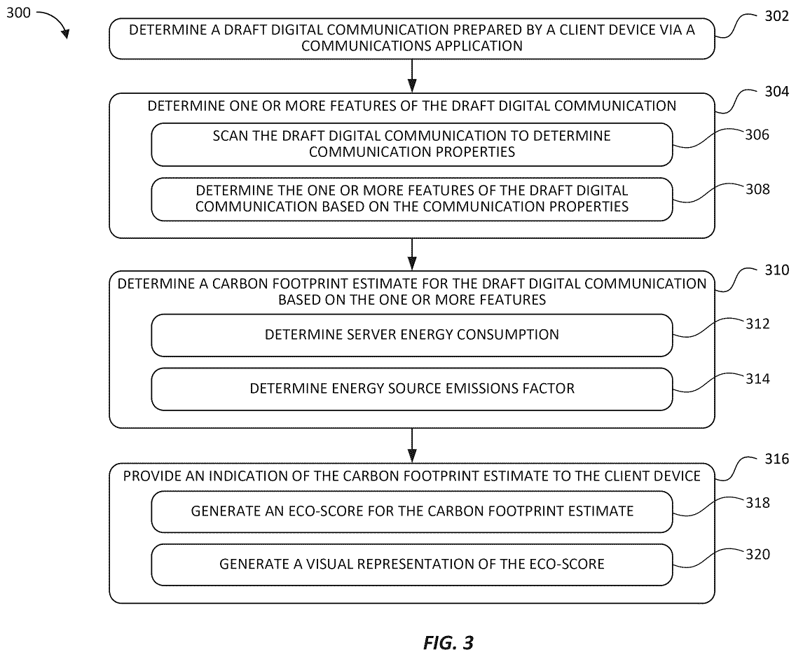

Referring now to FIG. 2, an example operational environment 200 in which an EcoCom engine 202 is implemented to monitor and analyze a digital communication 208 prepared by a client device 202 is provided, according to an embodiment herein. For ease of explanation, FIG. 2 is described in conjunction with FIG. 3, which provides an example EcoCom engine process, in particular a process 300 for providing the EcoCom engine 202 and one or more of its functions, according to an embodiment herein. While FIG. 3 is described with relation to FIG. 2, it should be appreciated that components, elements, and steps from any other Figures described herein may be equally applicable.

As illustrated, the operational environment 200 includes the client device 202, which may be the same or similar to the client device 102, having a communications application 220 executed thereon. The communications application 220 may be provided by an application service, such as the application service 101, to facilitate the exchange of digital communications, such as the digital communication 208. The communications application 220 may be a local application executed on the client device 202 or may be executed remotely, such as by the application service 101. To provide one or more of the functions described in the following sections, the communications application 220 includes an integration with the EcoCom engine 212, which may be the same or similar to the EcoCom engine 112.

As described above, in some embodiments, the EcoCom engine 212 is a plug-in for the communications application 220. As such, when a user of the client device 202 begins preparing a draft 221 of the digital communication 208 within the communications application 220, the EcoCom engine 212 detects the draft digital communication (302). In particular, the EcoCom engine 212 may include a communications detector 222 that detects the draft 221 of the digital communication 208 being prepared by the client device 202 via the communications application 220. For example, when a user opens a new draft digital communication 221 and begins adding content, the communication detector 222 detects the draft 221, thereby triggering the EcoCom engine 212 to perform one or more of the functions described herein. As expanded on below, as content is added to the draft 221, the EcoCom engine 212 monitors and analyzes the content to detect one or more features. Based on the features, the EcoCom engine 212 generates an Eco-score for the draft 221 and provides it to the client device 202. The communication detector 220 identifies the draft 221 as finalized when the digital communication 208 is sent to desired recipients. At that point, the Eco-score for the digital communication 208 is finalized and may be used for monitoring and tracking purposes by the EcoCom engine 212, as described below.

Responsive to detecting the draft 221 of the digital communication 208, the EcoCom engine 312 determines one or more features of the digital communication 208 (304). For example, the EcoCom engine 312 includes a feature module 224 containing a parser 226 that scans the digital communication 208 to determine the communication properties of the digital communication 208 (306). The communication properties of the digital communication 208 may include metadata associated with the digital communication 208 or header information of the digital communication 208. Header information includes subject line text, recipient field text, and timestamp information. As will be described in greater detail below, once the communication properties are determined, the EcoCom engine 212 uses the communication properties to determine the one or more features of the digital communication 208 (308). For ease of discussion, the features of the digital communication 208 are categorized into three main components. Specifically, the features of the digital communication 208 include attachments, chain communication, and a number of recipients indicated to receive the digital communication 208. Each of these is described in turn below.

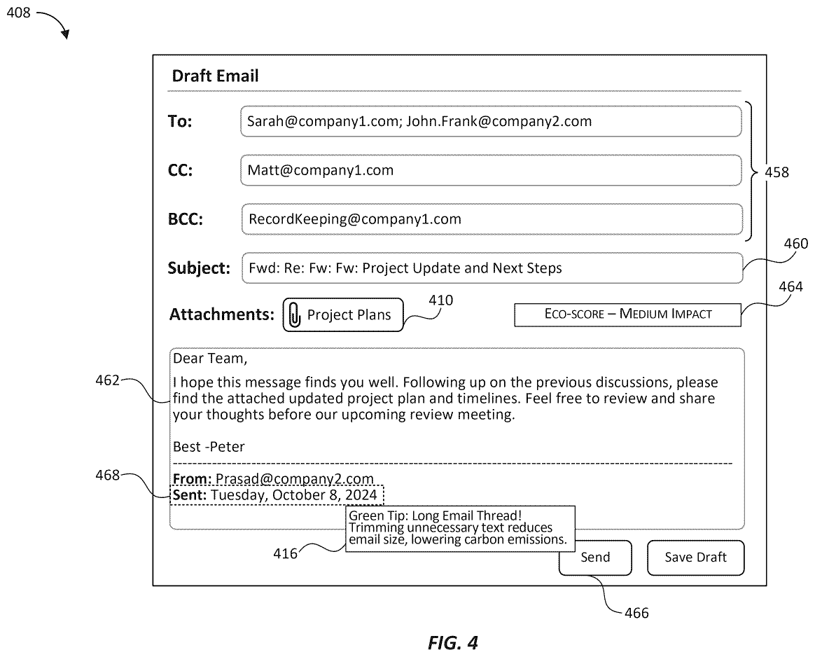

To determine what features a respective digital communication includes, the EcoCom engine 212 scans or parses the digital communication 208 to determine the corresponding communication properties. Referring now to FIG. 4, an example digital communication 408 is provided, according to an embodiment herein. The digital communication 408, which may be the same or similar to the digital communication 208, includes various communication properties, such as recipient fields 458, subject line field 460, an attachment 410, a content field 462, and timestamp information 468. When determining the features associated with the digital communication 408, the EcoCom engine 212 may parse the metadata associated with the digital communication 408 or may scan a draft of the digital communication 408 detecting the text provided in a respective field, such as the recipient fields 458, the subject line field 460, and content input. As can be appreciated, the EcoCom engine 212 may determine various information from the metadata and communication properties beyond the illustrated elements, however, for ease of illustration the communication components are limited. Examples of additional elements that may be determined by the EcoCom engine 212 by either metadata or header information include sender and recipient addresses, message ID, subject line, date and time stamps, reply-to address, received headers, return-path, authentication results (Sender Policy Framework (SPF), DomainKeys Identified Mail (DKIM), Domain-based Message Authentication (DMARC)), content-type and encoding, user agent, and attachment details.

Referring now to FIG. 2, in some embodiments, the feature module 224 determines that the digital communication includes an attachment, such as the attachment 410. In particular, the parser 226 of the feature module 224 parses the digital communication 208/408 to detect whether the digital communication 208 includes an attachment. For example, the parser 226 parses the metadata associated with the digital communication 408 and detects the attachment 410 based on the metadata. Once detected, the parser 226 determines the attachment properties associated with the attachment 410, such as attachment size, filename, and file type.

Responsive to determining the attachment properties, the EcoCom engine 212 may determine an initial environmental impact of the attachment 410. That is, the feature module 224 includes an attachment module 228 that can generate an initial environmental impact indication based on the attachment 410. For example, based on the attachment size of the attachment 410, the attachment module 228 may indicate whether the attachment 410 is a small, medium, or large attachment based on a predefined attachment size parameter. Research from the Radicati Group [2] suggest that the average email attachment size is approximately 10 MB, a trend driven by rich media and file sharing. However, as many attachments are unnecessary or superfluous to the content of the digital communication 208/408 (e.g., company logos and banners), by flagging attachment size as an initial matter allows a drafter to rethink the inclusion of a respective attachment 410.

To generate an initial environmental impact indication, the attachment module 228 may compare the attachment size of the attachment 410 to a predefined attachment threshold. For example, a default threshold may be 5 MB, however, the attachment threshold may be dynamic or organization specific, thereby adjusting to meet the productivity requirements of the individual drafters. The attachment threshold may be selected by the EcoCom engine 212 or predefined by an administrator or manager within a respective organization, to strike a balance between discouraging unnecessary large attachments while allowing attachments to be included in digital communications that are vital to maintaining productivity.

In some embodiments, based on the initial environment impact indication (e.g., whether an attachment size exceeds a predefined attachment threshold), the attachment module 228 generates a recommendation or indication of the attachment size. Specifically, the attachment module 228 in coordination with a visual representation generator 246 may generate a visual indication of the file size and its environmental impact. For example, with reference to FIG. 1, the attachment module 228 may generate the recommendation 116 flagging that the attachment 110 is too large and providing a tip to compress the attachment to reduce the carbon footprint of the digital communication 108. It should be appreciated, that in other embodiments, other visual representations or indications may include highlighting the attachment 110/410, changing a color or visually altering the attachment 110/410 to indicate the attachment size (e.g., changing the attachment 110/410 color to red if the attachment size exceeds the threshold or changing the attachment 110/410 color to green if the attachment size is below the threshold).

In some embodiments, the feature module 224 determines that the digital communication 208 is a chain communication. In particular, the parser 226 of the feature module 224 parses the digital communication 208/408 to determine whether the digital communication 208/408 is part of a chain communication. As noted above, chain communication refers to a digital message that is repeatedly forwarded or replied to between recipients. Consequently, a chain communication often includes multiple messages, all ‘linked’ or ‘chained’ together into a single, larger thread. Typically, chain communications contain similar communication properties, such as the subject line field 460 containing text indicating that the digital communication 408 has been repeatedly forwarded/replied to or contain timestamps, such as the timestamp information 468, indicating that the digital communication 408 contains content exchanged over an extended period of time (e.g., days, weeks, months). As such, the parser 226 may parse the metadata, such as the metadata including the Received Headers, Message-ID, or References header, and/or the header information of the digital communication 408, such as the subject line field 460 and the timestamp information 468 to determine whether or not the digital communication 408 is a chain communication.

The feature module 224 may include a chain communication module 230 that, based on the communication properties detected by the parser 226 determines whether or not the digital communication 208/408 is a chain communication. If the chain communication module 230 determines that the digital communication 208/408 is a chain communication, the chain communication module 230 may coordinate with the visual representation generator 246 to generate an indication of the environmental impact of the chain communication. For example, with reference to FIG. 4, the visual representation generator 246 may generate a recommendation 416 that indicates that the digital communication 408 is a chain communication and provide a tip to trim the unnecessary text to reduce the carbon footprint of the digital communication 408.

In some embodiments, the feature module 224 determines a number of recipients intended or indicated to receive the digital communication 208. In particular, the parser 226 of the feature module 224 parses the digital communication 208/408 to determine the number of indicated recipients. For example, with reference to FIG. 4, the parser 226 may parse the recipient fields 458 and provide the parsed information to a recipient module 232. The recipient module 232 determines a number of recipients indicated to receive the digital communication 208/408 based on the information identified by the parser 226.

Similar to the other features, if the recipient module 232 determines that a number of recipients is greater than a predefined threshold number, then the recipient module 232 may coordinate with the visual representation generator 246 to generate a recommendation indicating the environmental impact of the number of recipients. For example, if the predefined threshold number of recipients is 5, and the recipient module 232 detects that 8 recipients are indicated by the recipient fields 458, the visual representation generator 246 may generate a recommendation that the digital communication 208/408 includes too many recipients and recommend that the drafter trim the number recipients to only necessary recipients. Such a recommendation may be generated, especially in scenarios where there are an increased number or recipients indicated as CCs or BCCs to a digital communication 208/408.

As can be appreciated, as the drafter prepares the digital communication 208/408, the content of the digital communication 208/408 may evolve and change. As such, the feature module 224 analyzes the communication properties of the digital communication 208/408 at predefined intervals to allow for real-time insights into the digital communication's 208/408 environmental impact. With each predefined interval of time, the EcoCom engine 212 captures the metadata and header information of the digital communication 208/408 to update changes made to the draft digital communication 208/408. For example, if the feature module 224 generates an indication 244 of the environmental impact of the digital communication 208/408, such as the attachment size being too large, to the client device 202 and the drafter responsively compresses the attachment 410, then the EcoCom engine 212 may analyze an updated draft 248 of the digital communication 208/408 containing the compressed attachment 410. As such, at the next interval of analysis, the EcoCom engine 212 may update its recommendations or indications of the environmental impact of the digital communication 208 based on the updated draft 248. For example, responsive to determining that the attachment 410 is compressed and thus has a smaller attachment size, the EcoCom engine 212 may remove the recommendation 116 that the attachment is too large or update a respective visual indication to reflect the real-time environmental impact of the digital communication 208 (e.g., change the attachment 410 color from red to green).

Responsive to determining the one or more features of the digital communication 208, the EcoCom engine 212 may determine a carbon footprint estimate of the digital communication 208 (310). In particular, the EcoCom engine 212 may include a carbon footprint estimator 234 that computes a carbon footprint estimate for the digital communication based on the features. As will be expanded on below, the carbon footprint estimator 234 uses a combination of various factors associated with the digital communication 208 to compute the carbon footprint estimate. These factors include the one or more features of the digital communications 208 (e.g., attachment size, number of indicted recipients), a server energy consumption 240, and/or an energy source emissions factor 238. In some embodiments, the carbon footprint estimate is computed during drafting of the digital communication 208, while in other embodiments, the carbon footprint estimate is computed after the digital communication 208 is sent.

To compute the carbon footprint estimate of the digital communication 208/408, the carbon footprint estimator 234 may use the following equation for communications including an attachment:
CF (metric tons CO2e) α a*r*E_{ServerConsumption}*F,

And the following equation for communications without attachments:

$$CF ( metric tons CO 2 e ) = r * {E}_{ServerConsumption} * F ,$$

where,
α indicates proportionality;
CF=Carbon Footprint Estimate of respective digital communication;
a=attachment size;
r=numbers of recipients indicated to receive the digital communication;
E_{serverConsumption}=the server energy consumption 240; and
F=the energy source emission factors 238.

As previously noted, each time a digital communication 208 is transmitted, the servers that host the communications application 220 and facilitate the exchange use energy. This energy consumption occurs with every interaction, whether sending, receiving, or processing messages across the server infrastructure. As energy is consumed, the servers emit carbon. As such, to determine the carbon footprint estimate for the digital communication 208, the carbon footprint estimator 234 determines the server energy consumption 240 (312) and/or the energy source emissions factor 238 (314) associated with the communication application 220.

To determine the server energy consumption 240, the carbon footprint estimator 234 may estimate the server energy consumption 240 based on the communications application 220, specifically estimate the server energy consumption 240 based on the server power (in watts), uptime (in hours), and energy efficiency of the servers used to host the communications application 220. These metrics may be published by cloud providers, application services, or stored within a database 236A, as illustrated. It should be appreciated that while the database 236A is illustrated as the source of the server energy consumption 240 and the energy source emissions factor 238, this information may be received from other sources. For example, if the specific metrics for the communications application 220 are unavailable, then the carbon footprint estimator 234 may use industry averages to compute the server energy consumption 240.

Similarly, to determine the energy source emissions factor 238, the carbon footprint estimator 234 may estimate the carbon emissions required for powering the servers hosting the communications application 220 for the client device 202. That may include determining the energy mix (e.g., coal, natural gas, renewables) used to power the servers and estimating the respective carbon emissions associated with the energy mix. As noted above, the carbon footprint estimator 234 may determine this information from published data by cloud providers, application services, or query it from the database 236A. And if such information is unavailable, the carbon footprint estimator 234 may use industry averages to compute the energy source emissions factor 238.

The server energy consumption 240 and the energy source emissions factor 238 are determined for the digital communication 208 on a per recipient basis. That is, once the carbon footprint estimator 234 determines the server energy consumption 240 and/or the energy source emissions factor 238, depending on the embodiment, the carbon footprint estimator 234 may multiply each by the number of recipients indicated to receive the digital communication 208. Using the server energy consumption 240 and the energy source emissions factor 238, the carbon footprint estimator 234 then computes the carbon footprint estimate for the digital communication 208 using the above respective equation. The computed CF (metric tons CO2e) is then converted to kilograms (kg) of CO₂ equivalent, which is the standard unit used to measure carbon emissions.

Once computed, the EcoCom engine 212 provides an indication of the carbon footprint estimate to the client device 202 (316). For example, in some embodiments, the EcoCom engine 212 generates an eco-score using the carbon footprint estimate (318) and provides the indication 244 of the eco-score to the client device 202. In such embodiments, the EcoCom engine 212 includes an eco-score generator 242 that generates an eco-score for the digital communication 208 based on the carbon footprint estimate.

To generate the eco-score for the digital communication 208, the eco-score generator 242 may determine a range of carbon footprint values. This range of carbon footprint values may range from a Cₘᵢₙ, minimum carbon footprint value, and a Cₘₐₓ, a maximum carbon footprint value. These values may be predefined or may be automatically determined by the EcoCom engine 212 based on historical carbon emission factors associated with past digital communications exchanged by the client device 202 or client devices within a respective organization. In an example, the Cₘᵢₙ may be selected to represent the lowest emissions communications, such a s short text-only emails, and Cₘₐₓ may be selected to represent highest emissions communications, such as large communications with attachments and many recipients, as follows [4], [5]:

$${C}_{min} = 0.002 kg {CO}_{2 e} per digital communication ; and$$

$${C}_{max} = 0.2 kg {CO}_{2 e} per digital communication .$$

Once the range of carbon footprint values are determined, the eco-score generator 242 may generate a scoring scale, such as a zero to 10 scale, where 10 indicates the highest eco-friendliness communication and zero indicates the lowest eco-friendliness communication. It should be appreciated that any scoring scale may be selected but for ease of explanation, zero to 10 is used herein. The eco-score generator 242 then converts the carbon footprint estimate to an eco-score, such as via the following equation:

$$Eco - score = 10 - 9 ( \frac{C - {C}_{min}}{{C}_{max} - {C}_{min}} )$$

where,
C=carbon footprint estimate of the digital communication in kgCO₂ₑ. For example, using the example Cₘᵢₙ and Cₘₐₓ provided above, the eco-score generator 242 generates an eco-score of 7.8 for a digital communication having a carbon footprint estimate of 0.05 kgCO₂ₑ.

In some embodiments, the EcoCom engine 212 classifies each eco-score into a respective category indicating the environmental impact of the respective digital communication 208. For example, the EcoCom engine 212 may classify eco-scores into three categories of: Low Impact, Medium Impact, and High Impact. It should be appreciated that any categories or classification may be used, but for ease of illustration these three are described herein.

Based on the eco-score, the EcoCom engine 212 may then generate a visual representation indicating the environmental impact of the digital communication 208 (320). In particular, the visual representation generator 246 of the EcoCom engine 212 may generate a visual representation of the environmental impact. The following Table 1 illustrates an example classification of eco-scores and corresponding visual indication used to signify the environmental impact of a respective digital communication 208.

TABLE 1

| CATEGORY | ECO-SCORE RANGE | COLOR CODE |
|---|---|---|
| Low Impact | 7-10 | Green |
| Medium Impact | 4-6 | Yellow |
| High Impact | 1-3 | Red |

The visual indication, which may be a visual representation of the environmental impact of the digital communication 208 may be provided via the indication 244 to the client device 202. The visual indication may be provided in visual proximity to the digital communication 208 such to clearly communicate its relation to the digital communication 208.

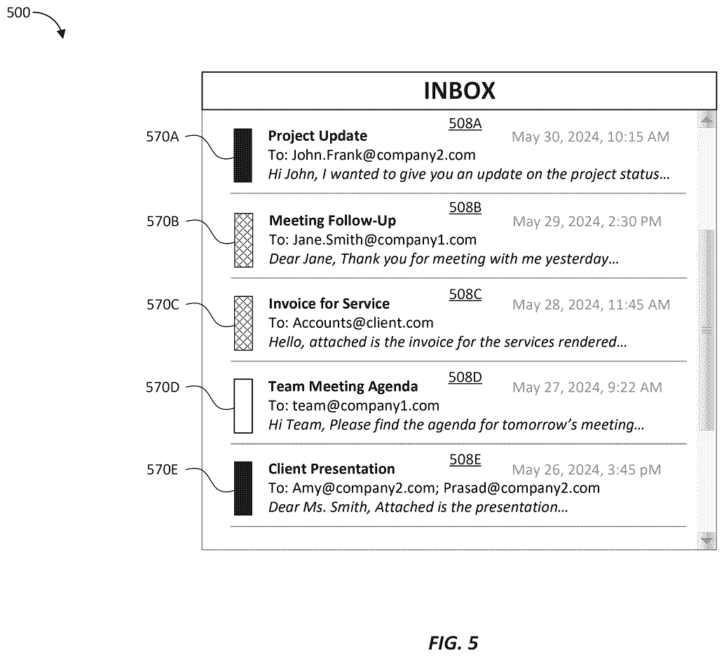

Referring now to FIG. 5, an example inbox 500 containing multiple digital communications 508A-E including respective visual indications 570A-E signifying the environmental impact of each is illustrated, according to an embodiment herein. As illustrated, each of the digital communications 508A-E includes a respective visual indication 570A-E indicating the environmental impact of the respective communication, such as the carbon footprint estimate computed for the respective communication. As shown, the visual indications 570A-E may visually communicate the environmental impact, such as the visual indications 570A and 570E indicating that the respective communications 508A and 508E have a high environmental impact, the visual indications 570B and 570C indicating that the respective communications 508B-C have a medium environmental impact, and the visual indication 570D indicating that the respective communication 570D has a low environmental impact. As can be appreciated, the visual indications 570A-E may be or include any visual cues indicating the environmental impact of a respective communication and should not be limited to the illustrated example.

Returning now to FIG. 2, in some embodiments, the EcoCom engine 212 may generate a summary 250 of the environmental impact of the digital communications exchanged by the client device 202. In such embodiments, the EcoCom engine 212 includes a summary generator 252 to generate the summary 250. To generate the summary 250, an aggregator 254 within the summary generator 252 aggregates the carbon footprint estimates associated with digital communications exchanged by the client device 202 via the communications application 220 over a predefined period of time. The predefined period of time may be a week, a month, a quarter, a year, or any other desired time period.

To aggregate the carbon footprint estimates associated with the digital communications exchanged over the predefined period of time, the aggregator 254 may query a database 236B for historical communications 256 exchanged during the time period. In some cases, instead of querying for the historical communications 256, the EcoCom engine 212 may query for the carbon footprint estimate and/or eco-score of the historical communications 256. It should be appreciated that while the database 236B is illustrated as separate from the EcoCom engine 212, in some embodiments, the database 236B may be part of the EcoCom engine 212. As such, when the EcoCom engine 212 computes a carbon footprint estimate and respective eco-score for a digital communication, the EcoCom engine 212 stores this information within the database 236B for future use, such as generation of the summary 250.

From the historical communications 256, the aggregator 254 aggregates various metrics related to the digital communications exchanged over the predefined period of time. These metrics include the number of emails sent, a total carbon footprint computed from the carbon footprint estimates of the historical communications 256, an average eco-score computed by averaging the eco-scores of the historical communications 256, and an attachment analysis summarizing the total size of attachments sent.

In some embodiments, based on the various metrics aggregated by the aggregator 254, the summary generator 252 may identify patterns within the historical communications 256. Patterns include peak sending times at which the client device 202 sends digital communications 208, a frequency for sending large attachments, and an eco-score distribution (e.g., percentage of digital communications falling into the high impact, medium impact, and low impact categories). Based on the above metrics, the summary generator 252 generates the summary 250. The summary 250 may include a visual representation of the metrics, such as various graphs, charts to display trends over time, such as monthly carbon emissions, average eco-scores, and peak sending times.

Once generated, the summary 250 is transmitted from the EcoCom engine 212 to the client device 202 where it is displayed via a user interface, such as an interface provided by the communications application 220.

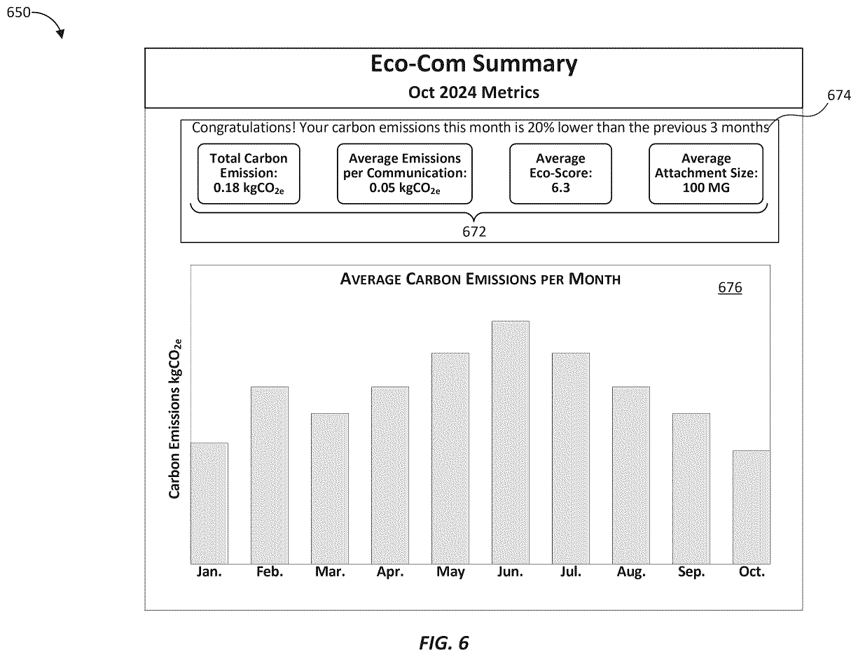

Referring now to FIG. 6, an example summary 650 is illustrated, according to an embodiment herein. The summary 650, which may be the same or similar to the summary 250, is generated by the summary generator 252 to indicate the environmental impact of digital communications exchanged by the client device 202 over a predefined period of time. The predefined period of time of the summary 650 is the month of October. As illustrated, the summary 650 includes metrics 672 indicating the total carbon emissions, the average emissions per communication, an average eco-score, and an average attachment size for the digital communications exchanged by the client device 202 during October 2024. In addition to the metrics 672, the summary 650 includes an evaluation 674 summarizing a comparison of the predefined period of time (October 2024) with previous time periods. As shown, the evaluation 674 notes that the client device 202 reduced its carbon emissions by 20% in October over the previous 3 months.

In addition to the metrics 672, the summary 650 also includes a graph 676 illustrating a pattern in the carbon emissions for digital communications exchanged in the previous months. As can be appreciated, various charts and graphs may be included in the summary 650 to capture the trends and patterns present within digital communications exchanged by the client device 202 over a given time period. Additionally, while the summary 650 illustrates the environmental impact of the client device's 202 digital communications, in some cases the summary 650 may be generated for more than one client device, such as a business or organization, or group within an organization. In this manner, the environmental impact of digital communications can be monitored and assessed at a desired level or group.

Referring now to FIG. 7, is a diagram of a system 700 configured to implement an EcoCom engine, according to an embodiment herein. The system 700 may be an example of an apparatus including a computing apparatus 791 that is representative of any system or collection of systems in which the various processes, systems, programs, services, and scenarios disclosed herein may be implemented. For example, computing apparatus 791 may be an example EcoCom engine, such as the EcoCom engines 112 or 212, a client device, such as the client device 102, 202, or 104A-N, or any of the subcomponents depicted in environments 100 or 200 of FIGS. 1-2, respectively. Examples of computing apparatus 791 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 791 may be implemented as a single apparatus, system, or device or may be implemented in a distributed manner as multiple apparatuses, systems, or devices. Computing apparatus 791 may include, but is not limited to, processing system 796, storage system 793, software 795, communication interface system 797, and user interface system 799. Processing system 796 may be operatively coupled with storage system 793, communication interface system 797, and user interface system 799.

Processing system 796 may load and execute software 795 from storage system 793. Software 795 may include an EcoCom engine 792, which may be representative of any of the operations for providing an EcoCom engine or any of its related functions, as discussed with respect to the preceding figures. When executed by processing system 796, software 795 may direct processing system 796 to operate as described herein for at least the various processes, such as the process 300, operational scenarios, and sequences discussed in the foregoing implementations. Computing apparatus 791 may optionally include additional devices, features, or functionality not discussed for purposes of brevity.

In some embodiments, processing system 796 may comprise a micro-processor and other circuitry that retrieves and executes software 795 from storage system 793. Processing system 796 may be implemented within a single processing device but may also be distributed across multiple processing devices or sub-systems that cooperate in executing program instructions. Examples of processing system 796 may include general purpose central processing units, graphical processing units, application specific processors, and logic devices, as well as any other type of processing device, combinations, or variations thereof.

Storage system 793 may comprise any memory device or computer-readable storage medium readable by processing system 796 and capable of storing software 795. Storage system 793 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 793 may also include computer readable communication media over which at least some of software 795 may be communicated internally or externally. Storage system 793 may be implemented as a single storage device but may also be implemented across multiple storage devices or sub-systems co-located or distributed relative to each other. Storage system 793 may comprise additional elements, such as a controller, capable of communicating with processing system 796 or possibly other systems.

Software 795 (including the EcoCom engine 792 among other functions) may be implemented in program instructions that may, when executed by processing system 796, direct processing system 796 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 795 may include additional processes, programs, or components, such as operating system software, virtualization software, or other application software. Software 795 may also comprise firmware or some other form of machine-readable processing instructions executable by processing system 796.

In general, software 795 may, when loaded into processing system 796 and executed, transform a suitable apparatus, system, or device (of which computing apparatus 791 is representative) overall from a general-purpose computing system into a special-purpose computing system as described herein. Indeed, encoding software 795 on storage system 793 may transform the physical structure of storage system 793. The specific transformation of the physical structure may depend on various factors in different implementations of this description. Examples of such factors may include, but are not limited to, the technology used to implement the storage media of storage system 793 and whether the computer-storage media are characterized as primary or secondary storage, as well as other factors.

For example, if the computer-readable storage medium is implemented as semiconductor-based memory, software 795 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 797 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 791 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an EcoCom engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; an Eco-Conscious Communication (EcoCom) engine comprising processor-executable instructions stored on the computer-readable storage medium; and one or more processors coupled to the computer-readable storage medium and configured to execute the processor-executable instructions to operate a, such that the processor-executable instructions, when executed by the one or more processors, direct the computing apparatus, to at least: detect a digital communication prepared by a client device within a communications application; determine one or more features of the digital communication; compute a carbon footprint estimate for the digital communication based on the one or more features; generate an indication of the carbon footprint estimate for the digital communication; and display the indication of the carbon footprint estimate for the digital communication via a user interface on the client device.

Example 2 is the computing apparatus of any previous or subsequent Example, wherein the processor-executable instructions to compute the carbon footprint estimate for the digital communication, when executed by the one or more processors, further direct the computing apparatus to: determine a server energy consumption based on the communications application; determine an energy source emissions factor based on the digital communication; and compute the carbon footprint estimate for digital communication using the server energy consumption, the energy source emissions factor, and the one or more features of the digital communication.

Example 3 is the computing apparatus of any previous or subsequent Example, wherein: the processor-executable instructions to determine the one or more features of the digital communication, when executed by the one or more processors, further direct the computing apparatus to: scan the digital communication to determine communication properties of the digital communication, wherein the communication properties comprise one of: metadata associated with the digital communication; or header information associated with the digital communication; and determine, based on the communication properties that the digital communication comprises a chain communication; and the processor-executable instructions to compute the carbon footprint estimate for the digital communication based on the one or more features, when executed by the one or more processors, further direct the computing apparatus to: compute the carbon footprint estimate for the digital communication based on the digital communication comprising the chain communication.

Example 4 is the computing apparatus of any previous or subsequent Example, wherein: the processor-executable instructions to determine the one or more features of the digital communication, when executed by the one or more processors, further direct the computing apparatus to: detect that the one or more features of the digital communication comprises an attachment; and parse metadata associated with the attachment to determine an attachment size; and the processor-executable instructions to compute the carbon footprint estimate for the digital communication based on the one or more features, when executed by the one or more processors, further direct the computing apparatus to: compute the carbon footprint estimate for the digital communication using the attachment size of the attachment.

Example 5 is the computing apparatus of any previous or subsequent aspect, wherein the one or more features of the digital communication comprises a number of recipients indicated to receive the digital communication, and the processor-executable instructions to compute the carbon footprint estimate for the digital communication based on the one or more features, when executed by the one or more processors, further direct the computing apparatus to: compute the carbon footprint estimate for the digital communication using the number of recipients indicated to receive the digital communication.

Example 6 is the computing apparatus of any previous or subsequent Example, wherein: the processor-executable instructions, when executed by the one or more processors, further direct the computing apparatus to: generate an eco-score for the digital communication based on the carbon footprint estimate; and the processor-executable instructions to generate an indication of the carbon footprint estimate for the digital communication, when executed by the one or more processors, further direct the computing apparatus to: generate a visual representation of the eco-score in visual proximity to the digital communication.

Example 7 is the computing apparatus of any previous or subsequent Example, wherein the processor-executable instructions, when executed by the one or more processors, further direct the computing apparatus to: determine a plurality of digital communications exchanged by the client device over a predefined period of time; determine a plurality of carbon footprint estimates associated with the plurality of digital communications, wherein for a carbon footprint estimate in the plurality of carbon footprint estimates corresponds to a digital communication of the plurality of digital communications exchanged by the client device during the predefined period of time; and generate a carbon footprint summary for the client device based on the plurality of carbon footprint estimates of the plurality of digital communications exchanged by the client device during the predefined period of time.

Example 8 is a method comprising: detecting, by an Eco-Conscious Communication (EcoCom) engine, a digital communication, wherein the digital communication is prepared by a client device via a communications application; parsing, by the EcoCom engine, the digital communication to determine one or more features of the digital communication; determining, by the EcoCom engine, a carbon footprint estimate for the digital communication based on the one or more features; and generating, by the EcoCom engine, a visual indication of the carbon footprint estimate, wherein the visual indication is displayed as associated with the digital communication via the client device.

Example 9 is the method of any previous or subsequent Example, wherein determining, by the EcoCom engine, the carbon footprint estimate for the digital communication based on the one or more features comprises: determining, by the EcoCom engine, a number of recipients indicated to receive the digital communication; determining, by the EcoCom engine, a server energy consumption based on the communications application and the number of recipients indicated to receive the digital communication; determining, by the EcoCom engine, an energy source emissions factor based on the number of recipients indicated to receive the digital communication; and computing, by the EcoCom engine, the carbon footprint estimate for digital communication using the server energy consumption, the energy source emissions factor, and the one or more features of the digital communication.

Example 10 is the method of any previous or subsequent Example, wherein parsing, by the EcoCom engine, the digital communication to determine one or more features of the digital communication comprises: scanning, by the EcoCom engine, the digital communication to determine communication properties of the digital communication, wherein the communication properties comprise one of: metadata associated with the digital communication; or header information associated with the digital communication; and determining, by the EcoCom engine, the one or more features of the digital communication based on the communication properties.

Example 11 is the method of any previous or subsequent Example, wherein: parsing, by the EcoCom engine, the digital communication to determine one or more features of the digital communication comprises: detecting, by the EcoCom engine, an attachment associated with the digital communication; parsing, by the EcoCom engine, metadata associated with the attachment; and determining, by the EcoCom engine, an attachment size based on the metadata of the attachment; and determining, by the EcoCom engine, a carbon footprint estimate for the digital communication based on the one or more features comprises: computing, by the EcoCom engine, the carbon footprint estimate for the digital communication using the attachment size of the attachment.

Example 12 is the method of any previous or subsequent Example, wherein the one or more features of the digital communication comprises one or more of: an attachment associated with the digital communication; a number of recipients indicated to receive the digital communication; or the digital communication comprising a chain communication.

Example 13 is the method of any previous or subsequent Example, wherein the method further comprises: determining, by the EcoCom engine, a plurality of digital communications exchanged by the client device over a predefined period of time; aggregating, by the EcoCom engine, a plurality of carbon footprint estimates associated with the plurality of digital communications to generate a carbon footprint total; determining, by the EcoCom engine, a feature pattern for the one or more features based on the plurality of carbon footprint estimates; and generating, by the EcoCom engine, a carbon footprint summary indicating the carbon footprint total for the client device and the feature pattern identified over the predefined period of time for the client device.

Example 14 is the method of any previous or subsequent Example, wherein the EcoCom engine comprises a plug-in of the communications application.

Example 15 is a computer-readable storage medium comprising processor-executable instructions configured to cause one or more processors to: detect, by an Eco-Conscious Communication (EcoCom) engine, a digital communication, wherein the digital communication is prepared by a client device via a communications application; parse, by the EcoCom engine, the digital communication to determine one or more features of the digital communication; determine, by the EcoCom engine, a carbon footprint estimate for the digital communication based on the one or more features; compute, by the EcoCom engine, an Eco-score for the digital communication based on the carbon footprint estimate; and provide, by the EcoCom engine, the Eco-score for the digital communication to the client device.

Example 16 is the computer-readable storage medium of any previous or subsequent Example, wherein the processor-executable instructions to determine, by the EcoCom engine, the carbon footprint estimate for the digital communication cause the one or more processors to further execute processor-executable instructions stored in the computer-readable storage medium to: determine, by the EcoCom engine, a number of recipients indicated to receive the digital communication; determine, by the EcoCom engine, a server energy consumption based on the communications application and the number of recipients indicated to receive the digital communication; and compute, by the EcoCom engine, the carbon footprint estimate for digital communication using the server energy consumption and the one or more features of the digital communication.

Example 17 is the computer-readable storage medium of any previous or subsequent Example, wherein the processor-executable instructions to provide, by the EcoCom engine, the Eco-score for the digital communication to the client device cause the one or more processors to further execute processor-executable instructions stored in the computer-readable storage medium to: generate, by the EcoCom engine, a visual representation of the Eco-score for the digital communication to the client device; and display, by the EcoCom engine, the visual representation within visual proximity to the digital communication via a user interface on the client device.

Example 18 is the computer-readable storage medium of any previous or subsequent Example, wherein the one or more features of the digital communication comprises one or more of: an attachment associated with the digital communication; a number of recipients indicated to receive the digital communication; or the digital communication comprising a chain communication.

Example 19 is the computer-readable storage medium of any previous or subsequent Example, wherein the processor-executable instructions cause the one or more processors to further execute processor-executable instructions stored in the computer-readable storage medium to: determine, by the EcoCom engine, a plurality of digital communications exchanged by the client device over a predefined period of time; aggregate, by the EcoCom engine, a plurality of carbon footprint estimates associated with the plurality of digital communications; generate, by the EcoCom engine, a carbon footprint total for the client device based on aggregation of the plurality of carbon footprint estimates; and generate, by the EcoCom engine, a carbon footprint summary indicating the carbon footprint total for the client device over the predefined period of time.

Example 20 is the computer-readable storage medium of any previous or subsequent Example, wherein the EcoCom engine comprises a plug-in of the communications application.

1. A computing apparatus comprising:
a non-transitory computer-readable storage medium;
an Eco-Conscious Communication (EcoCom) engine comprising processor-executable instructions stored on the non-transitory computer-readable storage medium; and
one or more processors coupled to the non-transitory computer-readable storage medium and configured to execute the processor-executable instructions such that the processor-executable instructions, when executed by the one or more processors, direct the computing apparatus, to at least:
detect, in real-time, a digital communication prepared by a client device within a communications application, wherein the EcoCom engine is operably coupled with the communications application;
parse the digital communication to determine one or more features of the digital communication;
compute a carbon footprint estimate for the digital communication based on the one or more features, a server energy consumption associated with the communications application, and an energy source emissions factor associated with the server energy consumption, the carbon footprint estimate corresponding to energy consumed by an application service for the communications application while processing, transmitting, and storing the digital communication;
generate an indication of the carbon footprint estimate for the digital communication;
display the indication of the carbon footprint estimate within visual proximity to the digital communication via a user interface of the communications application on the client device; and
cause the communications application to modify at least one feature of the digital communication based on user input received via the user interface in response to the indication of the carbon footprint estimate, wherein the modification is configured to reduce a carbon footprint of the digital communication.

2. The computing apparatus of claim 1, wherein the processor-executable instructions to compute the carbon footprint estimate for the digital communication, when executed by the one or more processors, further direct the computing apparatus to:
estimate the server energy consumption based on one or more servers used to host the communications application and to process, transmit, and store the digital communication;
compute the energy source emissions factor associated with an energy source supplying the one or more servers-based on the digital communication; and
compute the carbon footprint estimate for digital communication using the server energy consumption, the energy source emissions factor, and the one or more features of the digital communication.

3. The computing apparatus of claim 1, wherein:
the processor-executable instructions to determine the one or more features of the digital communication, when executed by the one or more processors, further direct the computing apparatus to:
scan the digital communication to determine communication properties of the digital communication, wherein the communication properties comprise one of:
metadata associated with the digital communication; or
header information associated with the digital communication; and
determine, based on the communication properties that the digital communication comprises a chain communication; and
the processor-executable instructions to compute the carbon footprint estimate for the digital communication based on the one or more features, when executed by the one or more processors, further direct the computing apparatus to:
compute the carbon footprint estimate for the digital communication based on the digital communication comprising the chain communication.

4. The computing apparatus of claim 1, wherein:
the processor-executable instructions to determine the one or more features of the digital communication, when executed by the one or more processors, further direct the computing apparatus to:
detect that the one or more features of the digital communication comprises an attachment; and
parse metadata associated with the attachment to determine an attachment size; and
the processor-executable instructions to compute the carbon footprint estimate for the digital communication based on the one or more features, when executed by the one or more processors, further direct the computing apparatus to:
compute the carbon footprint estimate for the digital communication using the attachment size of the attachment.

5. The computing apparatus of claim 1, wherein the one or more features of the digital communication comprises a number of recipients indicated to receive the digital communication, and the processor-executable instructions to compute the carbon footprint estimate for the digital communication based on the one or more features, when executed by the one or more processors, further direct the computing apparatus to:
compute the carbon footprint estimate for the digital communication using the number of recipients indicated to receive the digital communication.

6. The computing apparatus of claim 1, wherein:
the processor-executable instructions, when executed by the one or more processors, further direct the computing apparatus to:
generate an eco-score for the digital communication based on the carbon footprint estimate; and
the processor-executable instructions to generate an indication of the carbon footprint estimate for the digital communication, when executed by the one or more processors, further direct the computing apparatus to:
generate a visual representation of the eco-score in visual proximity to the digital communication.

7. The computing apparatus of claim 1, wherein the processor-executable instructions, when executed by the one or more processors, further direct the computing apparatus to:
determine a plurality of digital communications exchanged by the client device over a predefined period of time;
determine a plurality of carbon footprint estimates associated with the plurality of digital communications, wherein for a carbon footprint estimate in the plurality of carbon footprint estimates corresponds to a digital communication of the plurality of digital communications exchanged by the client device during the predefined period of time; and
generate a carbon footprint summary for the client device based on the plurality of carbon footprint estimates of the plurality of digital communications exchanged by the client device during the predefined period of time.

8. A method comprising:
detecting, by an Eco-Conscious Communication (EcoCom) engine, a digital communication, wherein the digital communication is prepared by a client device via a communications application;
parsing, by the EcoCom engine in operable communication with the communications application, the digital communication to determine one or more features of the digital communication;
determining, by the EcoCom engine, a carbon footprint estimate for the digital communication based on the one or more features, a server energy consumption associated with the communications application, and an energy source emissions factor associated with the server energy consumption, the carbon footprint estimate corresponding to energy consumed by an application service for the communications application while processing, transmitting, and storing the digital communication;
generating, by the EcoCom engine, a visual indication of the carbon footprint estimate, wherein the visual indication is displayed as associated with the digital communication via the client device; and
causing, by the EcoCom engine, the communications application to modify at least one feature of the digital communication based on user input received in response to the visual indication of the carbon footprint estimate, wherein the modification is configured to reduce a carbon footprint of the digital communication.

9. The method of claim 8, wherein determining, by the EcoCom engine, the carbon footprint estimate for the digital communication based on the one or more features comprises:
determining, by the EcoCom engine, a number of recipients indicated to receive the digital communication;
determining, by the EcoCom engine, the server energy consumption based on the communications application and the number of recipients indicated to receive the digital communication;
determining, by the EcoCom engine, the energy source emissions factor based on the number of recipients indicated to receive the digital communication; and
computing, by the EcoCom engine, the carbon footprint estimate for digital communication using the server energy consumption, the energy source emissions factor, and the one or more features of the digital communication.

10. The method of claim 8, wherein parsing, by the EcoCom engine, the digital communication to determine one or more features of the digital communication comprises:
scanning, by the EcoCom engine, the digital communication to determine communication properties of the digital communication, wherein the communication properties comprise one of:
metadata associated with the digital communication; or
header information associated with the digital communication; and
determining, by the EcoCom engine, the one or more features of the digital communication based on the communication properties.

11. The method of claim 8, wherein:
parsing, by the EcoCom engine, the digital communication to determine one or more features of the digital communication comprises:
detecting, by the EcoCom engine, an attachment associated with the digital communication;
parsing, by the EcoCom engine, metadata associated with the attachment; and
determining, by the EcoCom engine, an attachment size based on the metadata of the attachment; and
determining, by the EcoCom engine, a carbon footprint estimate for the digital communication based on the one or more features comprises:
computing, by the EcoCom engine, the carbon footprint estimate for the digital communication using the attachment size of the attachment.

12. The method of claim 8, wherein the one or more features of the digital communication comprises one or more of:
an attachment associated with the digital communication;
a number of recipients indicated to receive the digital communication; or
the digital communication comprising a chain communication.

13. The method of claim 8, wherein the method further comprises:
determining, by the EcoCom engine, a plurality of digital communications exchanged by the client device over a predefined period of time;
aggregating, by the EcoCom engine, a plurality of carbon footprint estimates associated with the plurality of digital communications to generate a carbon footprint total;
determining, by the EcoCom engine, a feature pattern for the one or more features based on the plurality of carbon footprint estimates; and
generating, by the EcoCom engine, a carbon footprint summary indicating the carbon footprint total for the client device and the feature pattern identified over the predefined period of time for the client device.

14. The method of claim 8, wherein the EcoCom engine comprises a plug-in of the communications application.

15. A non-transitory computer-readable storage medium comprising processor-executable instructions configured to cause one or more processors to:
detect, by an Eco-Conscious Communication (EcoCom) engine, a digital communication, wherein the digital communication is prepared by a client device via a communications application, wherein the EcoCom engine is operably coupled with the communications application;
parse, by the EcoCom engine, the digital communication to determine one or more features of the digital communication;
determine, by the EcoCom engine, a carbon footprint estimate for the digital communication based on the one or more features, a server energy consumption associated with the communications application, and an energy source emissions factor associated with the server energy consumption, the carbon footprint estimate corresponding to energy consumed by an application service for the communications application while processing, transmitting, and storing the digital communication;
compute, by the EcoCom engine, an Eco-score for the digital communication based on the carbon footprint estimate;
provide, by the EcoCom engine, the Eco-score for the digital communication for presentation via the communications application on the client device; and
cause, by the EcoCom engine, the communications application to modify at least one feature of the digital communication based on user input received in responsive to the Eco-Score, wherein the modification is configured to reduce a carbon footprint of the digital communication.

16. The non-transitory computer-readable storage medium of claim 15, wherein the processor-executable instructions to determine, by the EcoCom engine, the carbon footprint estimate for the digital communication cause the one or more processors to further execute processor-executable instructions stored in the computer-readable storage medium to:
determine, by the EcoCom engine, a number of recipients indicated to receive the digital communication;
determine, by the EcoCom engine, the server energy consumption based on the communications application and the number of recipients indicated to receive the digital communication; and
compute, by the EcoCom engine, the carbon footprint estimate for digital communication using the server energy consumption and the one or more features of the digital communication.

17. The non-transitory computer-readable storage medium of claim 15, wherein the processor-executable instructions to provide, by the EcoCom engine, the Eco-score for the digital communication to the client device cause the one or more processors to further execute processor-executable instructions stored in the computer-readable storage medium to:
generate, by the EcoCom engine, a visual representation of the Eco-score for the digital communication to the client device; and
display, by the EcoCom engine, the visual representation within visual proximity to the digital communication via a user interface on the client device.

18. The non-transitory computer-readable storage medium of claim 15, wherein the one or more features of the digital communication comprises one or more of:
an attachment associated with the digital communication;
a number of recipients indicated to receive the digital communication; or
the digital communication comprising a chain communication.

19. The non-transitory computer-readable storage medium of claim 15, wherein the processor-executable instructions cause the one or more processors to further execute processor-executable instructions stored in the computer-readable storage medium to:
determine, by the EcoCom engine, a plurality of digital communications exchanged by the client device over a predefined period of time;
aggregate, by the EcoCom engine, a plurality of carbon footprint estimates associated with the plurality of digital communications;
generate, by the EcoCom engine, a carbon footprint total for the client device based on aggregation of the plurality of carbon footprint estimates; and
generate, by the EcoCom engine, a carbon footprint summary indicating the carbon footprint total for the client device over the predefined period of time.

20. The non-transitory computer-readable storage medium of claim 15, wherein the EcoCom engine comprises a plug-in of the communications application.
